(19) United States
(12) Patent Application Publication
(10) Pub. No.: US 2008/0172829 A1
(43) Pub. Date: Jul. 24, 2008

(54) Caster Assembly

(75) Inventor: W. Collins White, Cicero, NY (US)

Correspondence Address: BOND, SCHOENECK & KING, PLLC, ONE LINCOLN CENTER, SYRACUSE, NY, 13202-1355, US

(73) Assignee: DEFENSHIELD, INC., East Syracuse, NY (US)

(21) Appl. No.: 12/017,910

(22) Filed: Jan. 22, 2008

Related U.S. Application Data
(60) Provisional application No. 60/885,749, filed on Jan. 19, 2007.

(51) Int. Cl. B60B 33/00

(52) U.S. Cl. 16/29

(57) ABSTRACT

The present invention relates generally to devices that aid in the mobilization of objects, and, more particularly, to such devices that can be mounted easily on the objects, held in place by the weight of the objects, and easily removed from the objects without leaving any indication that the devices were so used by the objects.

### CROSS-REFERENCE TO RELATED APPLICATION

The present application claims priority to U.S. Provisional Application No. 60/885,749, filed Jan. 19, 2007.

### BACKGROUND OF THE INVENTION

1. Field of Invention

The present invention relates generally to devices that aid in the mobilization of objects, and, more particularly, to such devices that can be mounted easily on the objects, held in place by the weight of the objects, and easily removed from the objects without leaving any indication that the devices were so used by the objects.

2. Description of Prior Art

There are many examples of immobile objects being converted into mobile objects through the use of a device such as a caster wheel. These caster wheels can be used on any number of objects such as carts, ladders, chairs, barriers, cabinets and other furniture and the like.

These objects (as well as other examples of objects that should be known by those skilled in the art) show that situations exist where it may be beneficial to use a device that converts an immobile object to a mobile object. Also, situations exist where it is not desirable or necessary for the conversion or modification to be permanent. Furthermore, it may be desirable or necessary not to affect the structural integrity of the mounting surface of the object by adding holes for fasteners, or otherwise leaving any indication that the device was so used by the object.

### SUMMARY OF THE INVENTION

In accordance with an embodiment of the present invention, devices that aid in the mobilization of objects, and, more particularly, devices that can be mounted easily on the objects, held in place by the weight of the objects, and easily removed from the objects without leaving any indication that the devices were so used by the objects are provided.

In accordance with an embodiment of the present invention, a device is provided which comprises a bracket composed of a material, such as metal, plastic, ceramic or a composite material; and one or more casters attached to the bracket. The device fits under an existing object to be mobilized. As the weight of the object is applied to the device the wall of the bracket is pushed against the object holding the device in place. When use of the device is no longer desired or needed, the device is easily removed by removing the weight of the object from the device.

### BRIEF DESCRIPTION OF THE DRAWINGS

The present invention will be more fully understood and appreciated by reading the following Detailed Description in conjunction with the accompanying drawings, in which:

FIG. 1 is a side view that illustrates a device that aids in the mobilization of objects according to an embodiment of the present invention.

FIG. 2 is a perspective view of the device illustrated in FIG. 1 according to an embodiment of the present invention.

FIG. 3 is a perspective view of a device that aids in the mobilization of objects according to an embodiment of the present invention.

FIG. 4 is another perspective view of the device illustrated in FIG. 3 according to an embodiment of the present invention.

FIG. 5 is a perspective view of two devices in accordance with an embodiment of the present invention coupled to an object according to an embodiment of the present invention.

FIG. 6 is an enlarged view of the devices illustrated in FIG. 5 coupled to an object according to an embodiment of the present invention.

FIG. 7 is a further enlarged view of one of the devices illustrated in FIGS. 5 and 6 coupled to an object according to an embodiment of the present invention.

### DETAILED DESCRIPTION

In accordance with an embodiment of the present invention, devices are provided that afford mobility to an object. The devices of an embodiment of the present invention may be mounted (or connected) to and used by an object to aid in said object's mobility, and may be removed, without leaving any indication that said device was ever used by said object (e.g., without affecting the structural integrity of the object).

In accordance with an embodiment of the present invention, devices are provided that are held into place on an object by exploiting the weight of the object, without the use of fasteners. Thus, the devices of an embodiment of the present invention may be connected without adding holes for the use of the fasteners or otherwise affecting in any way the structural integrity of an object.

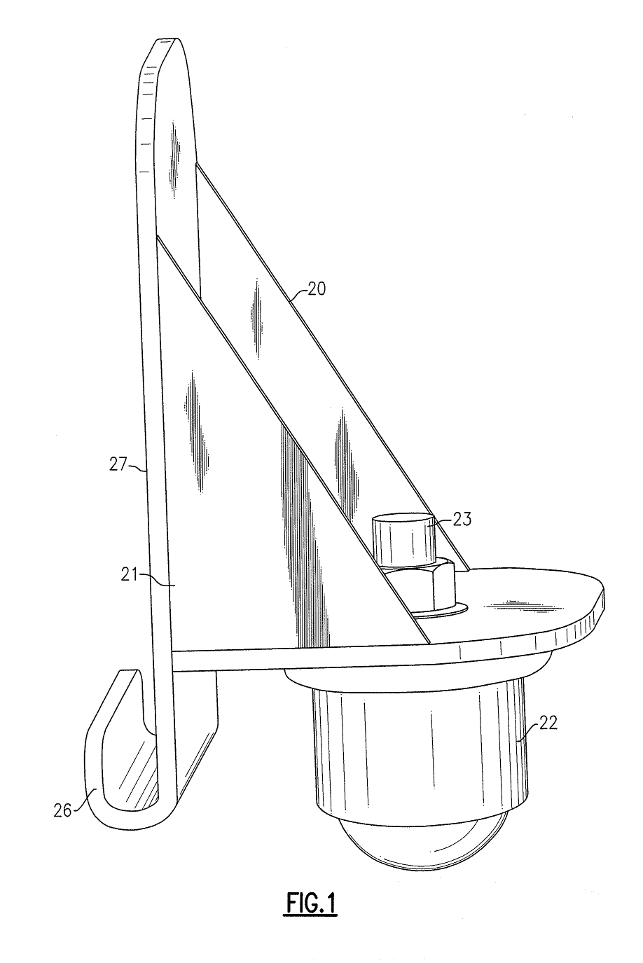

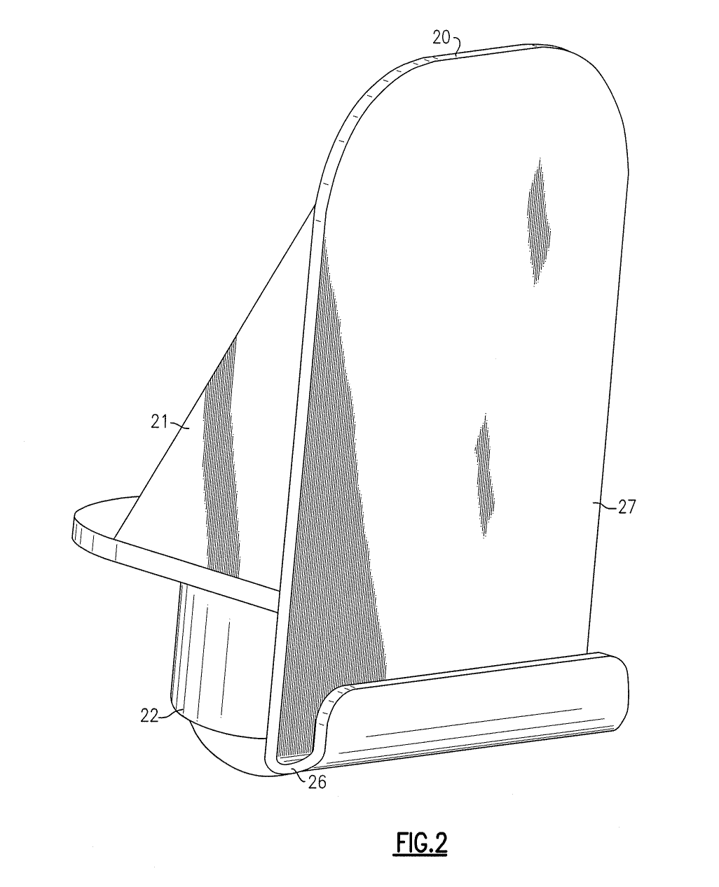

FIG. 1 is a side view that illustrates a device that aids in the mobilization of objects according to an embodiment of the present invention. This embodiment shows a caster assembly 20 comprising a bracket 21, a sphere (or ball) caster 22, a fastener means 23, a bracket lip 26, and a bracket wall 27.

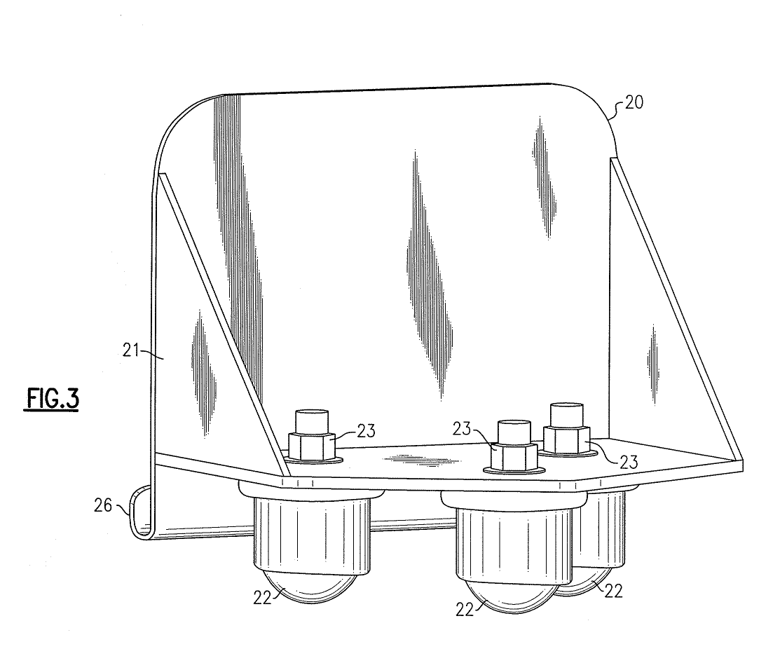

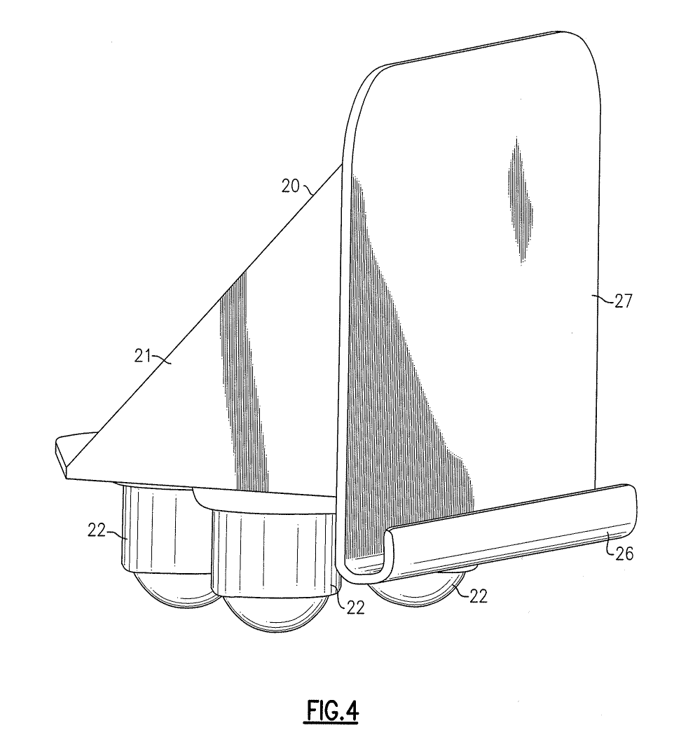

FIG. 2 is a perspective view of the device illustrated in FIG. 1 according to an embodiment of the present invention. This embodiment also shows a caster assembly 20 comprising a bracket 21, a sphere caster 22, a bracket lip 26, and a bracket wall 27.

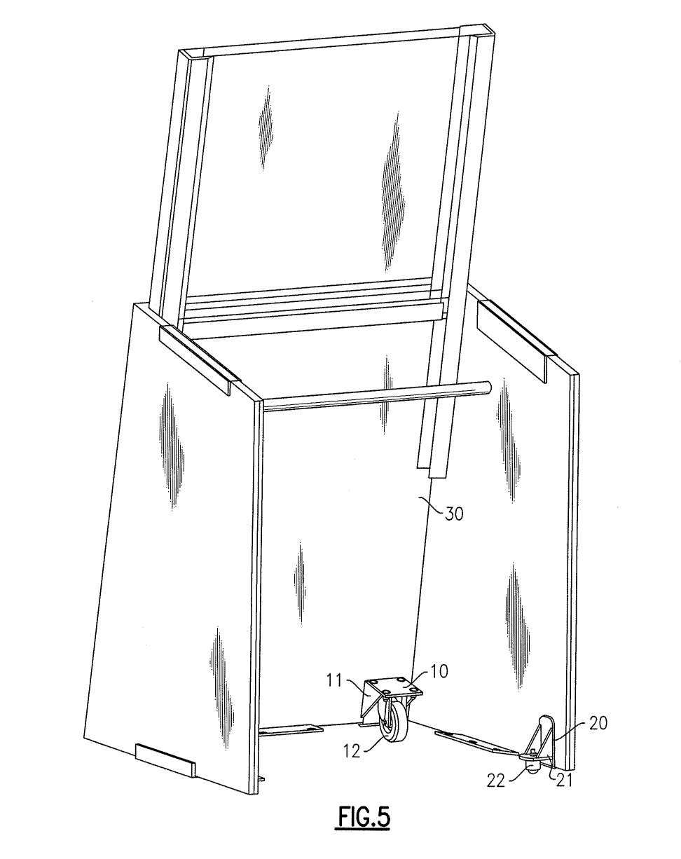

FIG. 3 is a perspective view of a device that aids in the mobilization of objects according to an embodiment of the present invention. This embodiment shows a caster assembly 20 comprising a bracket 21, three sphere casters 22, three fastener means 23, and a bracket lip 26.

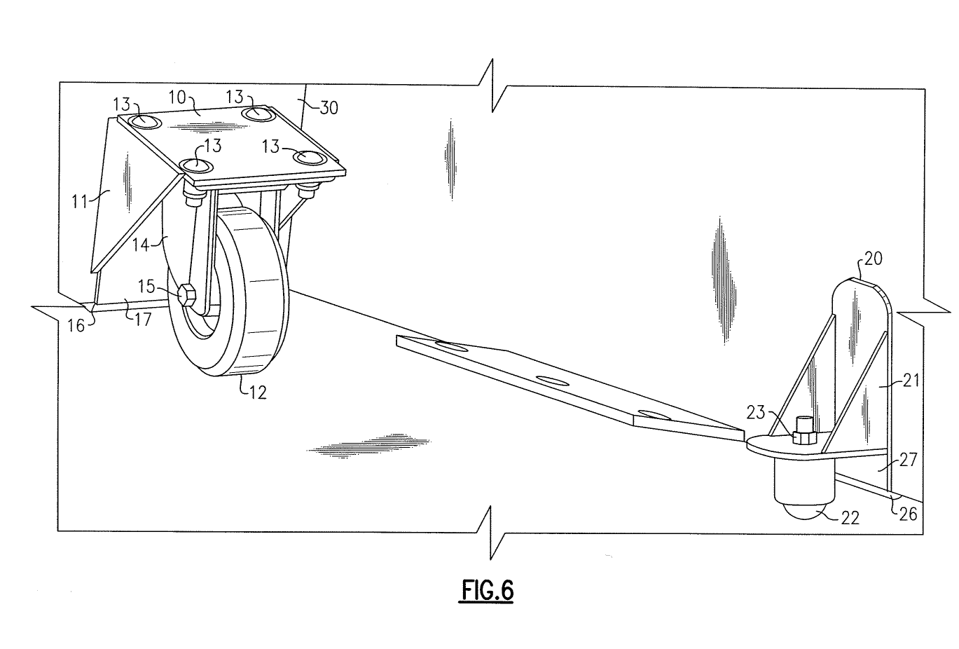

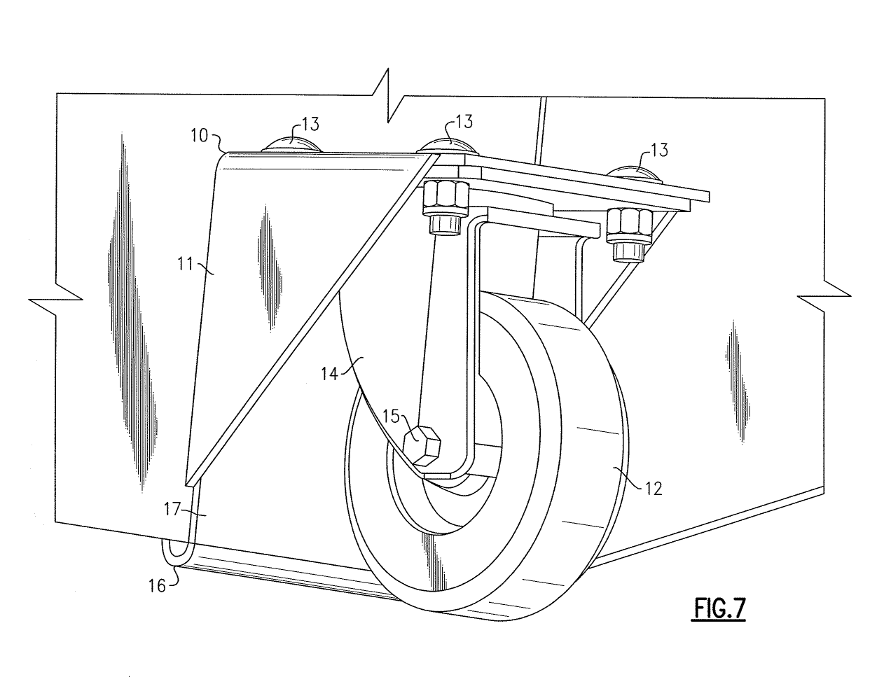

FIG. 4 is another perspective view of the device illustrated in FIG. 3 according to an embodiment of the present invention. This embodiment also shows a caster assembly 20 comprising a bracket 21, three sphere casters 22, a bracket lip 26, as well as a bracket wall 27.

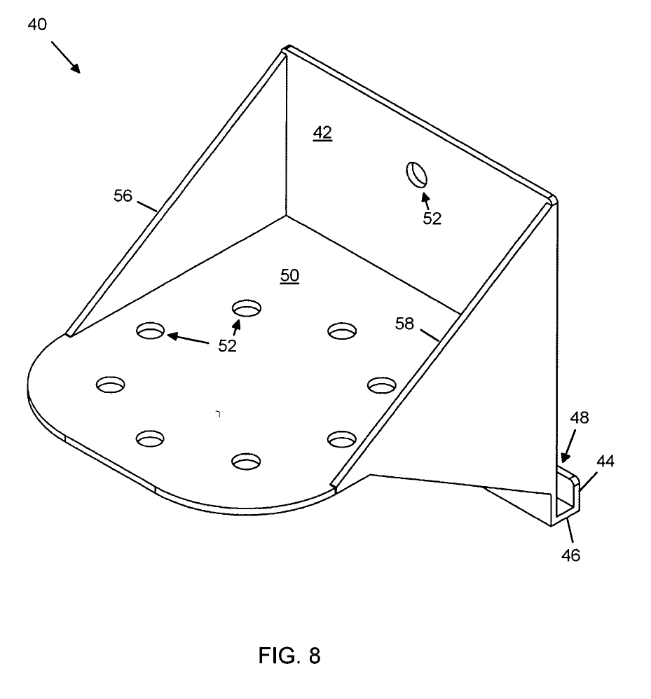

FIG. 5 is a perspective view of two devices in accordance with an embodiment of the present invention coupled to an object according to an embodiment of the present invention. This embodiment shows a caster assembly 10 comprising a bracket 11 and a caster wheel 12, and a caster assembly 20 comprising a bracket 21 and a caster sphere 22, coupled to and for use with a bullet resistant barrier 30 (as disclosed in U.S. Pat. No. 6,907,811, which is incorporated by reference in its entirety).

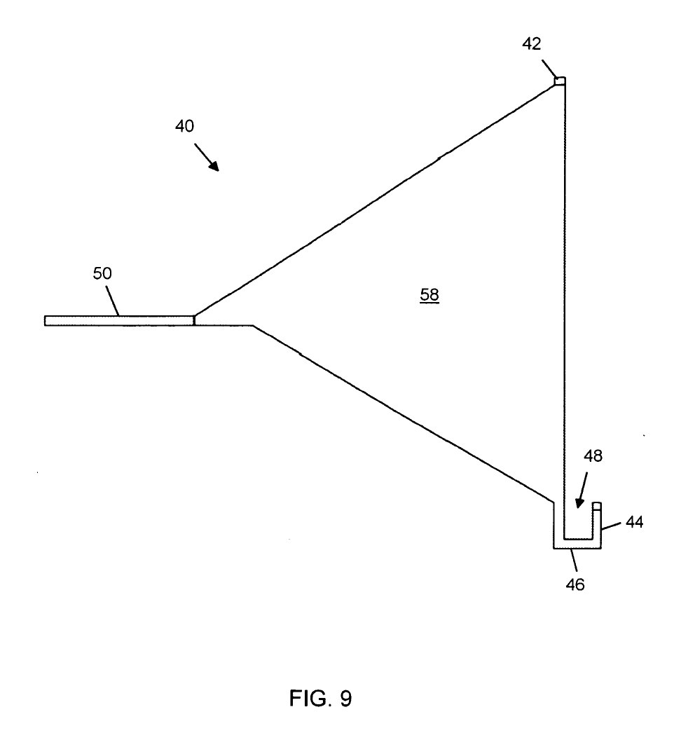

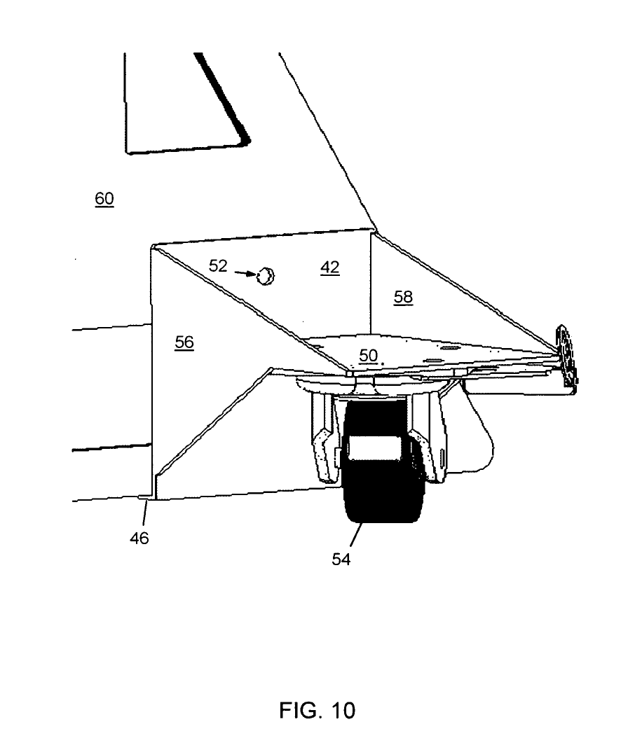

FIG. 6 is an enlarged view of the devices illustrated in FIG. 5 coupled to an object according to an embodiment of the present invention. This embodiment shows a caster assembly 10 comprising a bracket 11, caster wheel 12, four fastener means 13, wheel caster mounting structure 14, axle 15, bracket lip 16, bracket wall 17 coupled to and for use with a bullet resistant barrier 30. This embodiment also shows a caster assembly 20 comprising a bracket 21, caster sphere 22, fastener means 23, bracket lip 26, and a bracket wall 27 coupled to and for use with a bullet resistant barrier 30.

As shown in FIG. 6, the bottom of the bullet resistant barrier 30 is placed into the bracket lips 16 and 26 of the caster assemblies 10 and 20 respectively. The bullet resistant barrier 30 is secured to the bracket lips 16 and 26 of the caster assemblies 10 and 20 respectively through the use of the weight of the bullet resistant barrier 30. As the weight of the bullet resistant barrier 30 is applied to the bracket lips 16 and 26 of the caster assemblies 10 and 20 respectively, the bracket walls 17 and 27 of the caster assemblies 10 and 20 respectively are pushed against the bullet resistant barrier 30 holding the caster assemblies 10 and 20 in place on the bullet resistant barrier 30. When the use of the caster assemblies 10 and/or 20 are no longer desired or needed, the caster assemblies may be removed by removing the weight of the bullet resistant barrier 30 from the caster assemblies 10 and 20 leaving no indication on the bullet resistant barrier 30 that the caster assemblies 10 and 20 were used (by either compromising the structural integrity, scratching, or otherwise visually marking the bullet resistant barrier 30).

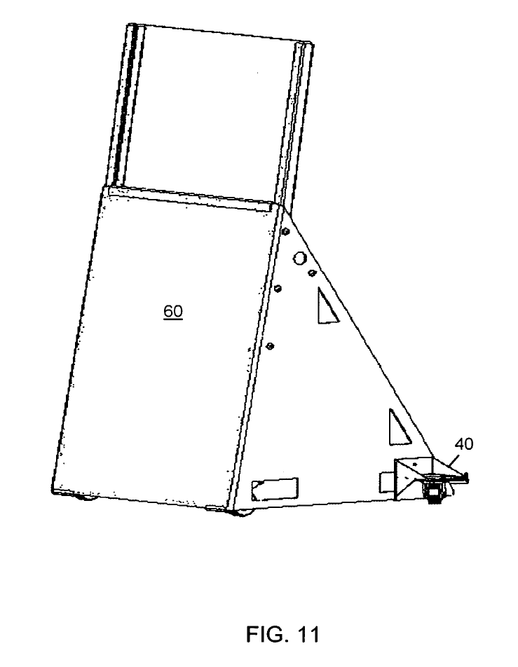

FIG. 7 is a further enlarged view of one of the devices illustrated in FIGS. 5 and 6 coupled to an object according to an embodiment of the present invention. This embodiment shows caster assembly 10 comprising a bracket 11, caster wheel 12, four fastener means 13, wheel caster mounting structure 14, axle 15, bracket lip 16, bracket wall 17 coupled to and for use with a bullet resistant barrier 30.

As in FIG. 6, FIG. 7 shows the bullet resistant barrier 30 placed into the bracket lips 16 of the caster assembly 10. The bullet resistant barrier 30 is secured to the bracket lip 16 of caster assembly 10 through the use of the weight of the bullet resistant barrier 30. As the weight of the bullet resistant barrier 30 is applied to the bracket lip 16 of the caster assembly 10, the bracket wall 17 of the caster assembly 10 is pushed against the bullet resistant barrier 30 holding the caster assembly 10 in place on the bullet resistant barrier 30. When use of caster assembly 10 is no longer desired or needed, caster assembly 10 may be removed by removing the weight of the bullet resistant barrier 30 from the caster assembly 10 leaving no indication on the bullet resistant barrier 30 that the caster assembly 10 was used (by either compromising the structural integrity, scratching, or otherwise visually marking the bullet resistant barrier 30).

There is seen in FIGS. 8-11 another embodiment of the present invention. Caster assembly 40 comprises a first member 42 extending vertically and a second member 44 extending parallel to first member 42 and held in spaced relation thereto via a U-shaped portion 46 integrally formed with the first and second portions. U-shaped portion 46, along with first and second members 42 and 44, respectively, thereby form a receiving slot 48 for retaining and supporting a planar member therein. Caster assembly 40 further includes a caster mounting member 50 extending perpendicularly from first member 42 and including a number of apertures 52 formed therethrough for interconnection to a caster, such as the ball casters 54 or wheel casters, as described above. Caster assembly 40 may further include apertures 52 formed in other locations for retaining caster assembly in place on a movable barrier. Caster assembly 40 further comprises side walls 56 and 58 extending on either side of first member 42 and mounting member 48. As seen in FIGS. 10 and 11, receiving slot 48 of caster assembly 40 is configured for attachment to the lower edge of a barrier 60, thereby providing mobility to barrier 60.

What is claimed is:

1. A caster mounting assembly for a mobile barrier having a lower edge, comprising:
a first member extending along a first plane;
a second member extending along a second plane that is substantially parallel to said first place, wherein said second member is held in spaced relation to said first member to define an clip for receiving said lower edge of said moveable barrier;
a third member extending in a third plane perpendicularly to said first member and adapted for attachment to a caster.

2. The assembly of claim 1, wherein said clip is defined by a U-shaped portion integrally connected to said first member and said second member that holds said second member in spaced relation to said first member.

3. The assembly of claim 2, further comprising four and fifth members extending in four and fifth planes, respectively, and interconnected to said first member and said third member.

4. The assembly of claim 3, wherein said four and fifth planes are parallel.

5. The assembly of claim 4, wherein each of said four and fifth members includes a first edge interconnected to said first member, and a second edge extending perpendicularly to said first edge and interconnected to said third member.

6. The assembly of claim 5, wherein said fourth member is interconnected to one side of said first member and said third member, and said fifth member is interconnected to an opposing side of first member and said third member.

7. The assembly of claim 6, wherein said four and fifth members are triangular.

8. The assembly of claim 7, wherein each of said four and fifth members includes a free edge extending from said first member to said third member.

9. The assembly of claim 5, wherein said second member is shorter than said first member.

10. A mobile barrier, comprising:
a first wall including a bottom edge, first and second sides, and a top edge;
second and third walls extending perpendicularly from said first and second sides of said first wall; and
a caster assembly attached to said bottom edge, wherein said caster assembly comprises:
a first member extending along a first plane;
a second member extending along a second plane that is substantially parallel to said first place, wherein said second member is held in spaced relation to said first member to define an clip for receiving said lower edge of said moveable barrier;
a third member extending in a third plane perpendicularly to said first member and adapted for attachment to a caster; and
a caster interconnected to said third member.

11. The assembly of claim 10, wherein said clip is defined by a U-shaped portion integrally connected to said first member and said second member that holds said second member in spaced relation to said first member.

12. The assembly of claim 11, further comprising four and fifth members extending in four and fifth planes, respectively, and interconnected to said first member and said third member.

13. The assembly of claim 12, wherein said four and fifth planes are parallel.

14. The assembly of claim 13, wherein each of said four and fifth members includes a first edge interconnected to said first member, and a second edge extending perpendicularly to said first edge and interconnected to said third member.

15. The assembly of claim 14, wherein said fourth member is interconnected to one side of said first member and said third member, and said fifth member is interconnected to an opposing side of first member and said third member.

16. The assembly of claim 15, wherein said four and fifth members are triangular.

17. The assembly of claim 16, wherein each of said four and fifth members includes a free edge extending from said first member to said third member.

18. The assembly of claim 17, wherein said second member is shorter than said first member.
